(19) United States
(12) Patent Application Publication
(10) Pub. No.: US 2013/0186108 A1
(43) Pub. Date: Jul. 25, 2013

(54) METHOD FOR GENERATING GIANT MAGNETOCALORIC MATERIALS

(71) Applicants: Robert Art DE GROOT, Heilig Landstichting (NL); Ekkehard BRUECK, Delft (NL)

(72) Inventors: Robert Art DE GROOT, Heilig Landstichting (NL); Ekkehard BRUECK, Delft (NL)

(73) Assignee: BASF SE, Ludwigshafen (DE)

(21) Appl. No.: 13/357,266

(22) Filed: Jan. 24, 2012

(51) Int. Cl. F25B 21/00; H01F 1/01

(52) U.S. Cl. 62/3.1; 252/62.55

(57) ABSTRACT

The invention relates to a method for generating giant magnetocaloric materials, the giant magnetocaloric materials obtained thereby and their use in magnetocaloric heat pumps, magnetocaloric power converters, actuators or magnetic switches.

The invention relates to a method for generating giant magnetocaloric materials, the giant magnetocaloric materials obtained thereby and their use in magnetocaloric heat pumps, magnetocaloric power converters, actuators or magnetic switches.

Limited resources and the wish for improved prosperity call for efficient use of energy. The UN Advisory Group on Energy and Climate Change recommends a target of 40% improved efficiency by 2030. Materials research can contribute significantly to reach this target. Magnetic refrigeration offers potential to achieve a 50% higher energy-efficiency compared to vapour compression refrigeration. This makes magnetic refrigeration a technology that attracts growing attention. Magnetic refrigeration is based on the magnetocaloric effect (MCE); solid magnetic materials heat up or cool down when an external magnetic field is applied or removed, due to the entropy transfer ΔS between the magnetic system and the crystal lattice. In a reversed process heat can be transformed into electricity with a thermomagnetic generator, see Kirol, L. D. and J. I. Mills, Numerical analysis of thermomagnetic generator. J. Appl. Phys., 56, 824-828 (1984). This device can be used to generate electricity from ‘waste heat’, heat that currently is released unused into the environment. Efficient magnetocaloric materials could therefore contribute significantly to a reduction in energy consumption.

The efficient coupling between lattice degrees of freedom and spin degrees of freedom in magnetic materials can be used for refrigeration and energy conversion. This coupling is enhanced in materials exhibiting the giant magnetocaloric effect.

Following the discovery of giant MCE in Gd₅(Si, Ge)₄, a number of magnetocaloric materials with a first-order magnetic phase transition (FOMT) have been intensively explored. In these materials, the FOMT enhances the magnetocaloric effect in the vicinity of the magnetic phase transition. The maximum isothermal entropy change is therefore often significantly greater than that of the benchmark material Gd that presents a second-order magnetic phase transition. By combining materials with different T_{C} in series, a higher efficiency and a greater temperature span than that of Gd are obtained. For optimal performance the materials used in such a composite regenerator need to have very similar magnetocaloric properties, to achieve a constant entropy change as function of temperature, see Rowe, A. & Tura, A. Experimental investigation of a three-material layered active magnetic regenerator, Int. J. Refrigeration 29, 1286-1293 (2006). The large thermal hysteresis frequently associated with the FOMT seriously hampers the application in a refrigeration cycle. Thermal and field hystereses are intrinsic properties of a first-order material. However, the size of this hysteresis may strongly depend on microstructure or strain in the system.

Thus, there is a continuing search for magnetocaloric materials showing a giant magnetocaloric effect and which can be used in magnetocaloric heat pumps, magnetocaloric power converters, actuators or magnetic switches.

The object underlying the present invention is to provide a method for generating giant magnetocaloric materials which can be employed successfully in the above applications.

The object is achieved according to the present invention by a method for generating giant magnetocaloric materials exhibiting a coexistence of strong and weak magnetism in alternate atomic layers or on distinct positions throughout the material, including the steps of
a) selecting at least one type of magnetic ions from the group consisting of Cr, Mn, Fe, Co, Ni in an amount of more than 50 atomic-%,
b) selecting at least one type of stabilizing chemical elements from the group consisting of P, As, Sb, Bi, Si, Ge, Sn, B, Al, Ga, In, Se in an amount of less than 50 atomic-%,
   the sum of atomic-% of magnetic ions and stabilizing chemical elements being 100 atomic-%,
c) performing an electronic structure calculation for the selected material and
d) determining whether there are strongly magnetic ions which lose the magnetic order only at the Curie temperature, and weakly magnetic or metamagnetic ions which lose at least 80% of their magnetic moment above the Curie temperature, coexisting in alternate atomic layers of the material or on distinct positions throughout the material,
   this coexistence of the two ion types leading to a giant magnetocaloric effect.

The object is furthermore achieved by giant magnetocaloric materials, generated by the above method.

Furthermore, the object is achieved by giant magnetocaloric materials showing a coexistence of strong and weak magnetism in alternate atomic layers or on distinct positions throughout the material.

Furthermore, the object is achieved by the use of these giant magnetocaloric materials in magnetocaloric heat pumps, magnetocaloric power converters, actuators or magnetic switches.

A corresponding paper on mixed magnetism for refrigeration and energy conversion was published by the present inventors in Adv. Energy Mater. 2011, 1, 1215-1219.

According to the invention it has been found that magnetocaloric materials exhibiting a coexistence of strong and weak magnetism in alternate atomic layers or on distinct positions throughout the material show a giant magnetocaloric effect.

This is especially true for materials in which at least one type of magnetic ions is present, selected from the group consisting of Cr, Mn, Fe, Co, Ni. This first type of magnetic ions is present in the magnetocaloric material in an amount of more than 50 atomic-%.

The stabilizing chemical elements are selected from the group consisting of P, As, Sb, Bi, Si, Ge, Sn, B, Al, Ga, In, Se. The stabilizing chemical elements are present in the magnetocaloric material in an amount of less than 50 atomic-%.

The sum of atomic-% of magnetic ions and stabilizing chemical elements is 100 atomic-% in each case.

The electronic structure calculation is preferably a band structure calculation.

The electronic structure calculation is performed as described below. Commercially available software can be employed for performing the electronic structure calculation. A typical software program is Wien2k.

The electronic structure calculation allows to determine whether there are strongly magnetic ions which lose the magnetic order only at the Curie temperature and weakly magnetic or metamagnetic ions which lose at least 80%, preferably at least 90%, especially at least 95% of their magnetic moment above the Curie temperature coexisting in alternate atomic layers of the material or on distinct positions throughout the material.

Once this last condition is fulfilled, the material will show a giant magnetocaloric effect.

According to one embodiment of the invention the distinct positions are distinguishable in their symmetry and coordination, i. e. they have a differing symmetry and coordination.

Preferably the distinct positions are tetrahedral and octahedral sites of the crystal lattice.

Preferred giant magnetocaloric materials show a Jahn-Teller effect.

The change in band structure is typically detectable by resonant spin-polarized photo emission.

The method for generating the giant magnetocaloric materials can also be regarded as a method for determining or finding giant magnetocaloric materials. In step d) the prerequisite for the giant magnetocaloric effect is determined, investigated or ascertained.

In step a) at least one type of the magnetic ions is selected, preferably one or two of the listed metals. Especially preferred, two of the listed metals are selected.

In step b) at least one type of stabilizing chemical elements is selected. Preferably, one or two stabilizing chemical elements are selected.

In step c) the term “electronic structure calculation” is understood in its broadest sense. The electronic structure calculation is performed by standard software, e. g. Wien2k, or as described in Phys. Rev. B 41, 5613 to 5626 (1990), J. Phys. C: Solid State Phys. 4, 2064 to 2083 (1971), J. Appl. Crystallogr. 41, 653 to 658 (2008) and Phys. Rev. B 54, 11169 to 11186 (1996).

In step d) the strongly magnetic ions and weakly magnetic or metamagnetic ions can be detected by analyzing local density of states diagrams for the ferromagnetic configuration and antiferromagnetic configuration, as shown in FIGS. 1 and 2.

The term “strong magnetism” means that the (strongly magnetic) ions lose the magnetic order only at the Curie temperature. The term “weak magnetism” means that the (weakly magnetic or metamagnetic) ions lose at least 80% of their magnetic moment above the Curie temperature. Thus, the local magnetic moments essentially totally disappear at the Curie temperature.

The term “giant magnetocaloric material” refers to materials showing a giant magneto-caloric effect of the type that was first discovered in Gd₅(Si, Ge)₄, see Phys. Rev. Lett. 78, 4494 to 4497 (1997).

The term “alternate atomic layers” defines a sequence of atomic layers in which every second atomic layer is occupied by ions having strong magnetism and every other second layer is occupied by ions showing weak magnetism.

The term “distinct positions throughout the material” means that in the crystal lattice specific positions are occupied by the strong magnetism ions and specific positions are occupied by the weak magnetism ions. For example, the distinct positions are distinguished in their symmetry and coordination as in the tetrahedral and octahedral sites of the crystal lattice.

In order to generate new giant magnetocaloric materials, first the selections in steps a) and b) are performed. Then, the electronic structure calculation of step c) is performed and the result is analysed with regard to strong and weak magnetism in alternate atomic layers. If such strong and weak magnetism in alternate atomic layers is determined according to step d), the material is regarded as a giant magnetocaloric material in the sense of the present invention.

If in step d), no alternate atomic layers or distinct positions throughout the materials for strong and weak magnetism are found, the material is disregarded.

Thus, the method according to the present invention allows identifying and generating giant magnetocaloric materials. Furthermore, the change in band structure can be detected by physical methods like resonant spin-polarized photo emission.

First principle electronic structure calculations, e. g. on hexagonal MnFe(P, Si) reveal a form of magnetism hitherto unknown: the coexistence of strong and weak magnetism in alternate atomic layers. The weak magnetism of Fe layers (disappearance of local magnetic moments at the Curie temperature) is responsible for a strong coupling with the crystal lattice while the strong magnetism in adjacent Mn-layers ensures Curie temperatures high enough to enable operation at and above room temperature. Varying the composition on these magnetic sublattices gives a handle to tune the working temperature and to achieve a strong reduction of the undesired thermal hysteresis. In this way we design novel materials based on abundantly available elements with properties matched to the requirements of an efficient refrigeration or energy-conversion cycle.

Here we report on a novel mechanism, the intercalation of weak and strong magnetism in adjacent lattice planes, to induce giant magnetocaloric effects. With this mechanism we can generate exceptionally favourable magnetocaloric properties, e. g. in broad regions of the Mn—Fe—P—Si system.

On replacing more than 10% of P by Si in Fe₂P the hexagonal crystal lattice is transformed into an orthorhombic one. MnFeP_{0.5}Si_{0.5} with a FOMT near room temperature, crystallizes in the hexagonal Fe₂P type structure that has four distinct lattice sites, the thermal hysteresis ΔT_{hys} of 35 K makes this material however unsuitable for applications, see Cam Thanh, D. T., Brück, E., Trung, N. T., Klaasse, J. C. P., Buschow, K. H. J., Ou, Z. Q., Tegus, O. & Caron, L., Structure, magnetism, and magnetocaloric properties of MnFeP₁₋ₓSiₓ compounds, J. Appl. Phys. 103, 07B318 (2008). In contrast to most other magnetocaloric materials the volume change in this material is rather small and we observe mainly a change in c/a ratio of the hexagonal lattice. In order to elucidate the origin of the observed magnetocaloric effect, electronic structure calculations were performed on the ferromagnetic ground-state, while the behaviour at the Curie temperature was modelled by a supercell obtained by doubling the unit cell (allowing for anti-ferromagnetic configurations). The calculations show that layers occupied by manganese are strongly magnetic; implying that the magnetic order only is lost at the Curie temperature. The size of the Mn moment is reduced from 2.8μ_{B} in the ferromagnetic phase to 2.6μ_{B} in the paramagnetic phase. Iron-layers show weak itinerant magnetism: here the Fe moment in the ferromagnetic phase is 1.54μ_{B}, while in the paramagnetic phase it vanishes (±0.003μ_{B}). The non bonding electron density at the Fe site below T_{C} shifts to a distribution which is strongly hybridized with Si/P above T_{C}. The loss of moments on the iron site is also clear from the partial density of states as function of energy. It shows identical curves for the two spin directions above the Curie temperature, in sharp contrast with manganese.

Such a combination of strong and weak magnetism in one compound is unexpected. Weak magnetism is rare; it is found in materials like ZrZn₂ or Ni₃Al. Curie temperatures are low (for example, ZrZn₂: 33 K; Ni₃Al: 23-58 K depending on composition). Mixed magnetism is directly related to the giant magneto-caloric effect, because in solids the existence of magnetic moments competes with chemical bonding. This is best illustrated in case of a half filled d-shell: the non-magnetic case allows a maximum in chemical bonding (like all half-filled shells), but the high-spin state does not show bonding, since the majority and minority subbands are completely filled and empty respectively. The loss of the magnetic moments of iron enables the strong coupling to the lattice above the Curie temperature resulting in the discontinuity of the c/a ratio leading to the FOMT.

On the other hand, strong magnetism of the manganese layers ensures a Curie temperature near room temperature.

Experimentally we studied the effect of changing the lattice sites occupations. Both Fe substitutions on the Mn sublattice or Mn substitutions on the Fe sublattice and an increase in Si content give rise to a decrease in ΔT_{hys}. With increasing Mn content T_{C} decreases while an increase of Fe content results in an increase of T_{C}. From these trends we derive that a large ΔSₘ coupled with a small ΔT_{hys} can be obtained by balancing the Mn:Fe ratio and the P:Si ratio. Furthermore, T_{C} can be tuned by changing the Mn:Fe and P:Si ratios simultaneously to keep both a large ΔSₘ and a small ΔT_{hys}. These trends also hold for slightly non-stoichiometric compounds. By concurrently changing Mn:Fe and P:Si ratios in MnₓFe_{1.95-x}P_{1-y}Si_{y} compounds, the working temperature can be controlled between 210 and 430 K for x=1.35, y=0.46 and x=0.66 and y=0.42, respectively, while the transition remains steep and the ΔT_{hys} remains small (1-1.5 K).

The entropy changes as function of temperature, derived from magnetic isotherms through the Maxwell relations, are displayed in FIG. 3. The absolute value of ΔSₘ reaches 18 Jkg⁻¹K⁻¹ around both 215 and 350 K, under a magnetic field change of 0-2 T. The peak values are rather stable (between 12.8-18.3 Jkg⁻¹K⁻¹) throughout the whole temperature range from 220 to 380 K. These values are about 4 times greater than that of Gd (see the data included in FIG. 3) for tuneable temperatures. Note that for the same effect more than twice the field change namely 0-5 T is required for MnFe(P, As). Thus, with the current materials much cheaper magnets may be employed for a magnetocaloric refrigerator. Because the large effect is observed over a broad range of compositions, one can achieve an equally large MCE over a wide temperature interval by cascading several alloys with slightly different compositions in one active magnetic regenerator.

Because the effect is still large above the boiling point of water, the materials can be used in magnetocaloric generators to transform abundant waste heat into electricity. This generator shall also contain a series of different materials to utilize the full temperature span from room temperature up to the temperature of the heat source. Because the entropy change observed in a field change from 0-1 T is already rather large, this simple generator can work efficiently. This is due to a magnetic-field-induced transition with a very small magnetic hysteresis, which occurs in these compounds at low fields. The extremely small magnetic hysteresis is in line with the observed small ΔT_{hys}, indicating a low energy barrier for nucleation of the FOMT.

Combining weak and strong magnetism in a single material gives the possibility to effectively couple spin and lattice degrees of freedom. In this way we simultaneously achieved giant magnetocaloric effect and a small thermal hysteresis in Mn—Fe—P—Si compounds of hexagonal Fe₂P-type structure by varying Mn:Fe, P:Si. The working temperature can be controlled between 210 and 430 K by concurrently changing Mn:Fe and P:Si ratios. The combination of several alloys with slightly different compositions in one active magnetic regenerator will allow for efficient magnetic refrigeration with large temperature span. Earth-abundant and non-toxic elements, industrially-mass-produced raw materials, and a simple powder-metallurgy preparation method make Mn—Fe—P—Si compounds particularly affordable. The discovery of these high-performance low-cost magnetic refrigerants paves the way for commercialization of magnetic refrigeration and magnetocaloric power-conversion. Additionally, the insight into the importance of the coexistence of strong and weak magnetism enables us to search specifically for new magnetocaloric materials.

The invention is further illustrated by the following examples.

First principle electronic structure calculations were performed using the localized spherical wave method (LSW) and the ab-initio total-energy and molecular-dynamics program (VASP) further described below.

### EXAMPLE 1

### Sample Preparation

Mn—Fe—P—Si compounds were prepared by ball milling and solid-state reactions from starting materials consisting of Mn (99.9%), Si (99.999%) chips, the binary compound Fe₂P (99.5%) and red-P (99.7%) powder. The powder obtained after milling for 10 hours was pressed into tablets. The tablets were sealed under Ar in quartz ampoules then sintered at 1373 K for 2 hours and annealed at 1123 K for 20 hours before slow cooling in the oven to room temperature. Powder X-ray diffraction patterns were obtained in a PANalytical X-pert Pro diffractometer with Cu Kα radiation, secondary flat crystal monochromator and X'celerator RTMS Detector system. Magnetic measurements were carried out using the RSO mode in a SQUID (Superconducting Quantum Interference Device) magnetometer (Quantum Design MPMS 5XL). The instrument's thermal lag of about 0.4 K with 1 K/min sweep rate around room temperature was obtained by measuring a Gd sample (3N Alfa Aesar) mounted in the same way as the other samples mentioned above.

### EXAMPLE 2

### Band Structure

Ab initio band structure calculations were performed using the localized spherical wave method (LSW) described in van Leuken, H., Lodder, A., Czyżyk, M. T., Springelkamp, F. & de Groot, R. A. Ab initio electronic-structure calculations on the Nb/Zr multilayer system, Phys. Rev. B 41, 5613-5626 (1990) using the scalar-relativistic Hamiltonian. We used the local density exchange-correlation potential according to Hedin, L. & Lundqvist, B. I. Explicit local exchange-correlation potentials, J. Phys. C: Solid State Phys. 4, 2064-2083 (1971), inside space filling and therefore overlapping spheres around the atomic constituents. Self consistency was assumed when changes in the local partial charges in the atomic spheres decreased to less than 10⁻⁵. In the construction of the LSW basis the spherical waves were augmented by solutions of the scalar relativistic equations indicated by the atomic-like symbols 4s, 4p and 3d for the transition metals and 3s and 3p for silicon and phosphorus, the internal angular momentum summation to augment the Hankel functions on neighbouring sites included 4f electrons for the transition metals and 3d states for silicon and phosphorous. The calculations simulating temperatures above the Curie temperature employed supercells in the xy and z directions with antiferromagnetic (z) or ferrimagnetic (xy) starting magnetic configurations; the size of the initial moments were the ones obtained in the calculation for the ferromagnetic case. The spin polarized density of states for the first case is illustrated in FIGS. 1 and 2. Subtle mixing prevented the (antiferro- or ferri-)magnetic starting configuration to fall back to the ground state.

The visualization of the change in electron density is generated using the program VESTA with the VASP data as input, see Momma, K. & Izumi, F., A three-dimensional visualization system for electronic and structural analysis, J. Appl. Crystallogr. 41, 653-658 (2008) and Kresse, G., Furthmüller, J., Efficient iterative schemes for ab initio total-energy calculations using a plane-wave basis set Phys. Rev. B 54, 11169-11186 (1996).

### Phase Transition and Hysteresis

The effect of changing the lattice sites occupations is best illustrated graphically. For the alloy MnFe(P, Si) forming in the hexagonal Fe₂P we observe almost perfect occupation of Fe on tetrahedral 3f sites and Mn on pyramidal 3g sites. We performed both Fe substitutions on the Mn sublattice or Mn substitutions on the Fe sublattice. Astonishingly, with increasing Mn content T_{C} decreases while an increase of Fe content results in an increase of T_{C} (FIG. 4). Si and P occupy almost randomly the 1b and 2c sites and an increase in Si content gives rise to an increase of T_{C}. Deviations from the perfect occupation of the Mn and Fe sublattices and an increase in Si content lead to a decrease in ΔT_{hys}.

### FIGURE LEGENDS

FIG. 1 shows the local density of states for Manganese (top) and Iron (bottom) for the ferromagnetic configuration

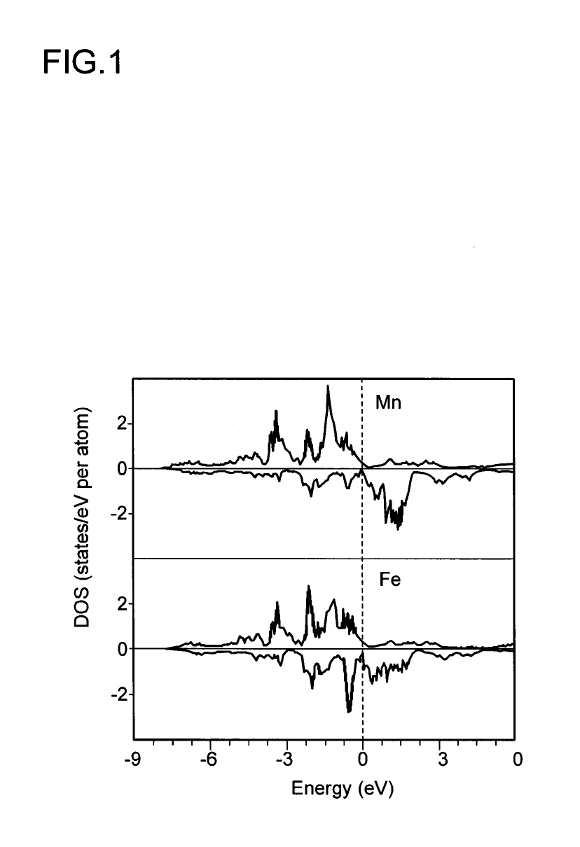

FIG. 2 shows the local density of states for Manganese (top) and Iron (bottom) for the antiferromagnetic configuration in the z direction.

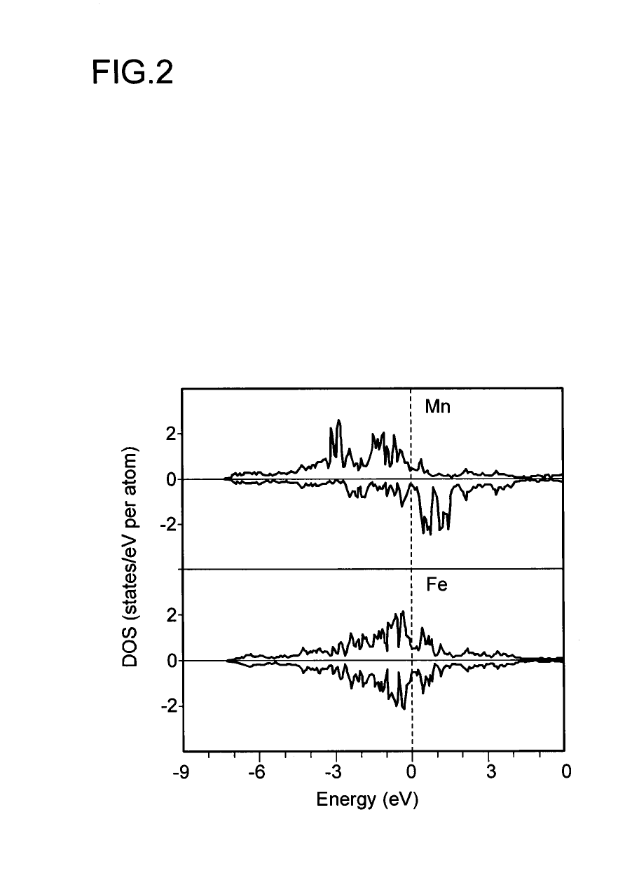

FIG. 3 shows the isothermal magnetic entropy change under a field change of 0-1 T (open curves) and 0-2 T (solid curves) for some typical MnₓFe_{1.95-x}P_{1-y}Si_{y} compounds. The data of Gd metal are included for comparison.

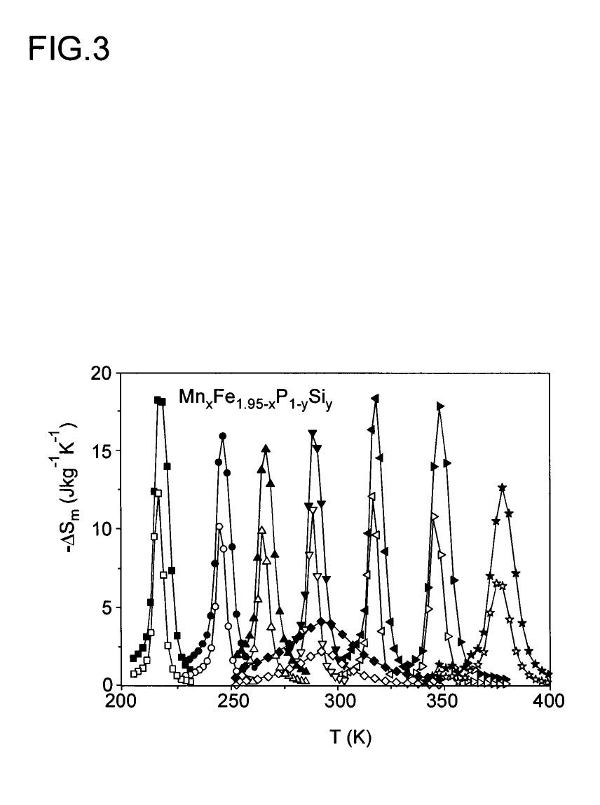

1. Method for generating giant magnetocaloric materials exhibiting a coexistence of strong and weak magnetism in alternate atomic layers or on distinct positions throughout the material, including the steps of
a) selecting at least one type of magnetic ions from the group consisting of Cr, Mn, Fe, Co, Ni in an amount of more than 50 atomic-%,
b) selecting at least one type of stabilizing chemical elements from the group consisting of P, As, Sb, Bi, Si, Ge, Sn, B, Al, Ga, In, Se in an amount of less than 50 atomic-%,
the sum of atomic-% of magnetic ions and stabilizing chemical elements being 100 atomic-%,
c) performing an electronic structure calculation for the selected material and
d) determining whether there are strongly magnetic ions which lose the magnetic order only at the Curie temperature, and weakly magnetic or metamagnetic ions which lose at least 80% of their magnetic moment above the Curie temperature, coexisting in alternate atomic layers of the material or on distinct positions throughout the material,
this coexistence of the two ion types leading to a giant magnetocaloric effect.

2. The method according to claim 1, wherein the distinct positions are distinguishable in their symmetry and coordination.

3. The method according to claim 1, wherein the distinct positions are tetrahedral and octahedral sites of the crystal lattice.

4. The method according to claim 1, wherein the giant magnetocaloric materials shows a Jahn-Teller effect.

5. The method according to claims 1 to 4, wherein the change in band structure is detectable by resonant spin-polarized photo emission.

6. Giant magnetocaloric material, generated by the method of claim 1.

7. Giant magnetocaloric material showing a coexistence of strong and weak magnetism in alternate atomic layers or on distinct positions throughout the material.

8. Magnetocaloric heat pumps, magnetocaloric power converters, actuators or magnetic switches, containing giant magnetocaloric materials according to claim 6.
